(19) United States
(12) Patent Application Publication
(10) Pub. No.: US 2012/0024829 A1
(43) Pub. Date: Feb. 2, 2012

(54) LASER MACHINING DEVICE

(75) Inventor: YUNG-LUN HUANG, Tu-Cheng (TW)

(73) Assignee: HON HAI PRECISION INDUSTRY CO., LTD., Tu-Cheng (TW)

(21) Appl. No.: 12/944,742

(22) Filed: Nov. 12, 2010

(30) Foreign Application Priority Data
Jul. 30, 2010 (TW) 99125454

(51) Int. Cl. B23K 26/38

(52) U.S. Cl. 219/121.68; 219/121.67

(57) ABSTRACT

A laser machining device for forming dots on a substrate includes a light-combining assembly having a first reflection surface and a second reflection surface, a first laser source module, and a second laser source module. The first laser source module emits a first laser beam to the first reflection surface along a first light path. The second laser source module emits a second laser beam to the second reflection surface along a second light path. The light-combining assembly combines the reflected first and second laser beams into a third laser beam to focus on the substrate. The light-combining assembly is moveable between the first laser source module and the second laser source module. The second laser source module is fixed relative to the first laser source module, such that a sum of the length of the first light path and the length of the second light path is maintained constant.

### BACKGROUND

1. Technical Field

The present disclosure relates to laser machining technology and, particularly, to a laser machining device.

2. Description of Related Art

Laser machining devices are preferred for use in dot-pattern-formation on a bottom surface of a light guide plate. Generally, the laser machining device includes a laser source and a laser head. Laser beams emitted from the laser source reach the laser head and then are projected onto a bottom surface of a substrate to form a dot. The laser head is driven to move relative to the substrate to form dots in different positions on the bottom surface by a driving member. Therefore, a light guide plate or a light guide plate insertion is formed. The light guide plate insertion is then used in a molding die to form a light guide plate.

However, during the dot-pattern-formation process, the length of the light path from the laser source to the laser head changes with movement of the laser head. Intensity of the laser beam projection onto the bottom surface decreases with the length of the light path. Therefore, the intensity of the laser beam projecting on different positions on the bottom surface is not uniform. This results different sizes and depths of dots formed.

Therefore, it is desirable to provide a laser machining device and a method for manufacturing a light guide plate which can overcome or at least alleviate the limitations described.

### BRIEF DESCRIPTION OF THE DRAWINGS

FIG. 1 is a schematic view of a laser machining device for forming dots on a substrate, according to a first exemplary embodiment.

FIG. 2 is a planar view of the substrate of FIG. 1 with the dots formed.

FIG. 3 is a schematic view of a laser machining device for forming dots on a substrate, according to a second exemplary embodiment.

FIG. 4 is a flowchart of a method for manufacturing a light guide plate, according to a third exemplary embodiment.

FIG. 5 is a flowchart of a method for manufacturing a light guide plate, according to a fourth exemplary embodiment.

### DETAILED DESCRIPTION

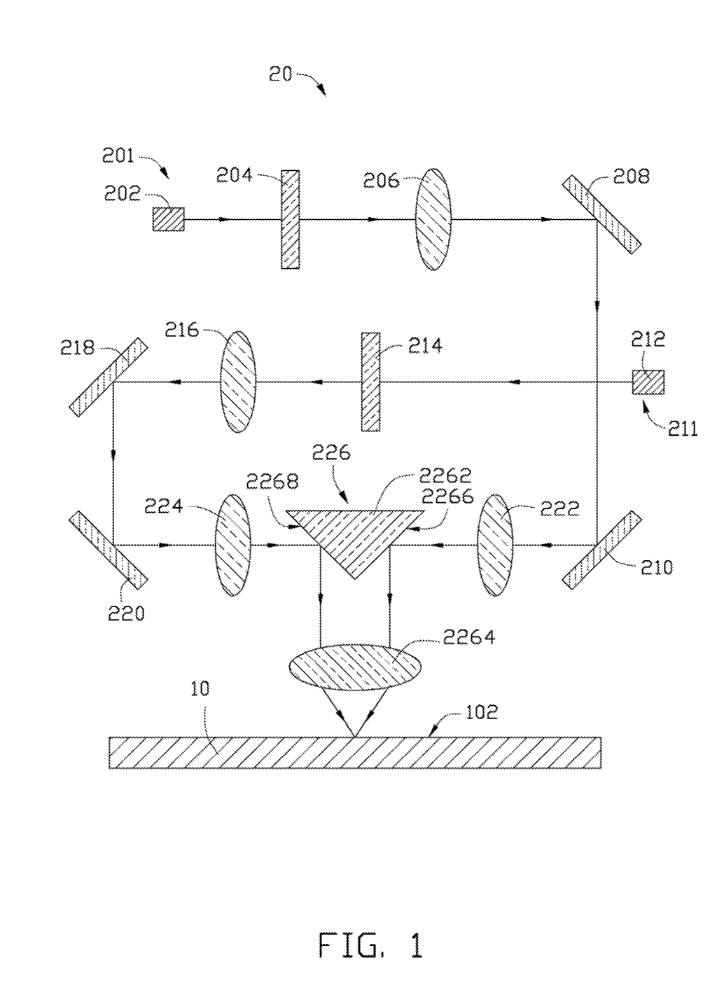

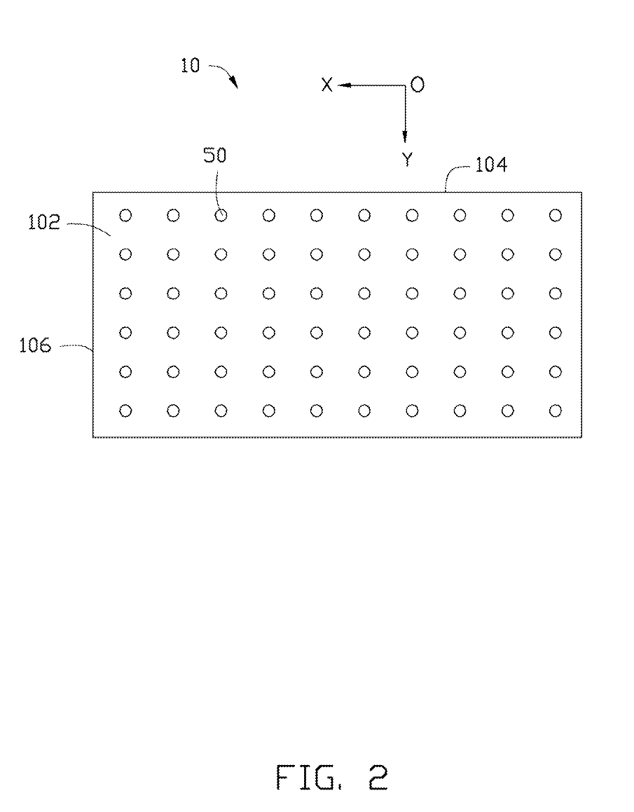

Referring to FIGS. 1-2, a laser machining device 20, according to a first exemplary embodiment, is used to form a dot pattern including a number of dots 50 on a substrate 10.

The substrate 10 includes a surface 102 opposite to the laser machining device 20. The surface 102 is substantially rectangular and includes two first sides 104 and two second sides 106. The first sides 104 are substantially parallel to each other. The second sides 106 are substantially parallel to each other. The first sides 104 are substantially perpendicular to the second sides 106. The dots 50 are formed on the surface 102.

The laser machining device 20 includes a first laser source 202, a first filter element 204, a first light condensing element 206, a first light reflection element 208, a second light reflection element 210, a second laser source 212, a second filter element 214, a second light condensing element 216, a third light reflection element 218, a fourth light reflection element 220, a third light condensing element 222, a fourth light condensing element 224, and a light-combining assembly 226. In particular, the first laser source 202, the first filter element 204, the first light condensing element 206, the first light reflection element 208, the second light reflection element 210, and the third light condensing element 222 cooperatively form a first laser source module 201. The second laser source 212, the second filter element 214, the second light condensing element 216, the third light reflection element 218, the fourth light reflection element 220, and the fourth light condensing element 224 cooperatively form a second laser source module 211.

The first laser source 202 is configured for emitting a first laser beam. The first filter element 204 is positioned between the first laser source 202 and the first light condensing element 206. The first filter element 204 is configured for filtering a weak portion of the first laser beam. The first light condensing element 206 is positioned between the first filter element 204 and the first light reflection element 208. The first light condensing element 206 is configured for condensing the first laser beam. The first light reflection element 208 is configured for reflecting the first laser beam condensed by the first light condensing element 206 toward the second light reflection element 210. The second light reflection element 210 is configured for reflecting the first laser beam reflected by the first light reflection element 208 toward the third light condensing element 222. The third light condensing element 222 is positioned between the second light reflection element 210 and the light-combining assembly 226. The first laser beam emitted from the first laser source 202 passes through the first filter element 204, the first light condensing element 206 and then is reflected by the first light reflection element 208 and the second light reflection element 210 toward the third light condensing element 222, and finally reaches the light-combining assembly 226 to form a first light path.

The second laser source 212 is configured for emitting a second laser beam. The second laser source 212 is fixed relative to the first laser source 202. The second filter element 214 is positioned between the second laser source 212 and the second light condensing element 216. The second filter element 214 is configured for filtering a weak portion of the second laser beam. The second light condensing element 216 is positioned between the second filter element 214 and the third light reflection element 218. The second light condensing element 216 is configured for condensing the second laser beam. The third light reflection element 218 is configured for reflecting the second laser beam condensed by the second light condensing element 216 toward the fourth light reflection element 220. The fourth light reflection element 220 is configured for reflecting the second laser beam reflected by the third light reflection element 218 toward the fourth light condensing element 224. The fourth light condensing element 224 is positioned between the fourth light reflection element 220 and the light-combining assembly 226. The second laser beam emitted from the second laser source 212 passes through the second filter element 214, the second light condensing element 216 and then is reflected by the third light reflection element 218 and the fourth light reflection element 220 toward the fourth light condensing element 224, and finally reaches the light-combining assembly 226 to form a second light path.

The light-combining assembly 226 is moveable between the first laser source 202 and the second laser source 212. In this embodiment, the light-combining assembly 226 is driven to move along a direction perpendicular to the reflected first laser beam and the reflected second laser beam by a driving member. A sum of the length of the first light path and the length of the second light path is maintained constant. The light-combining assembly 226 includes a reflection unit 2262 and a condensing unit 2264. The reflection unit 2262 has a triangular section and includes a first reflection surface 2266 and a second reflection surface 2268 connecting to the first reflection surface 2266. The first reflection surface 2266 is symmetrical to the second reflection surface 2268. In this embodiment, the first laser beam reaches the first reflection surface 2266, and the second laser beam reaches the second reflection surface 2268. An angle of incidence of the first laser beam on the first reflection surface 2266 is equal to that of the second laser beam on the second reflection surface 2268. The first reflection surface 2266 and the second reflection surface 2268 are configured for respectively reflecting the first and second laser beams in a manner that the reflected first and second laser beams are parallel to each other. The condensing unit 2264 is a light converging lens. In this embodiment, the focus of the light converging lens focuses on the surface 102 of the substrate 10.

In this embodiment, the first light reflection element 208, the second light reflection element 210, the third light reflection element 218, and the fourth light reflection element 220 are reflection lenses.

When the laser machining device 20 forms dots 50 on the surface 102, the first laser beam and the second laser beam are reflected by the first reflection surface 2266 and the second reflection surface 2268 toward the condensing unit 2264 to form a third laser beam. The third laser beam focuses on a point on the surface 102 to form a dot 50. The first laser source 202 and the second laser source 212 are re-activated after the light-combining assembly 226 moves to a subsequent position along the first side 104 (positive direction on an X axis shown in FIG. 2) so that a subsequent dot 50 is formed on the surface 102. As this action is repeated, a first line of dots 50 is formed on the surface 102. The laser machining device 20 then moves along the second side 106 (positive direction on a Y axis shown in FIG. 2). The first laser source 202 and the second laser source 212 are re-activated after the light-combining assembly 226 moves to a subsequent position along the negative direction of the first side 104 (negative direction on the X axis shown in FIG. 2) so that a subsequent dot 50 is formed on the surface 102. As this action is repeated, a second line of dots 50 is formed on the surface 102. Operations are repeated until the dot pattern is complete on the surface 102.

During the dot-formation process, when the light-combining assembly 226 moves to increase the length of the first light path and the intensity of the first laser beam decreases accordingly, the length of the second light path decreases to increase the intensity of the second laser beam. When the light-combining assembly 226 moves to decrease the length of the first light path and the intensity of the first laser beam increases accordingly, the length of the second light path increases to decrease the intensity of the second laser beam. Therefore, the total intensity of the first laser beam and the second laser beam will be substantially maintained constant. As a result, the intensity of the third laser beam focused on different positions on the surface 102 is substantially maintained constant. The sizes and depths of the dots 50 are approximately consistent.

In other embodiments, the substrate 10 may be round or triangular. The first filter element 204, the second filter element 214, the third light condensing element 222, and the fourth light condensing element 224 may be omitted.

It is to be understood that in alternative embodiments, the laser machining device 20 can include only a first laser source 202, a second laser source 212, and a light-combining assembly 226. The light-combining assembly 226 is moveably positioned between the first laser source 202 and the second laser source 212. The first laser beam emitted from the first laser source 202 directly reaches the light-combining assembly 226. The second laser beam emitted from the second laser source 212 directly reaches the light-combining assembly 226.

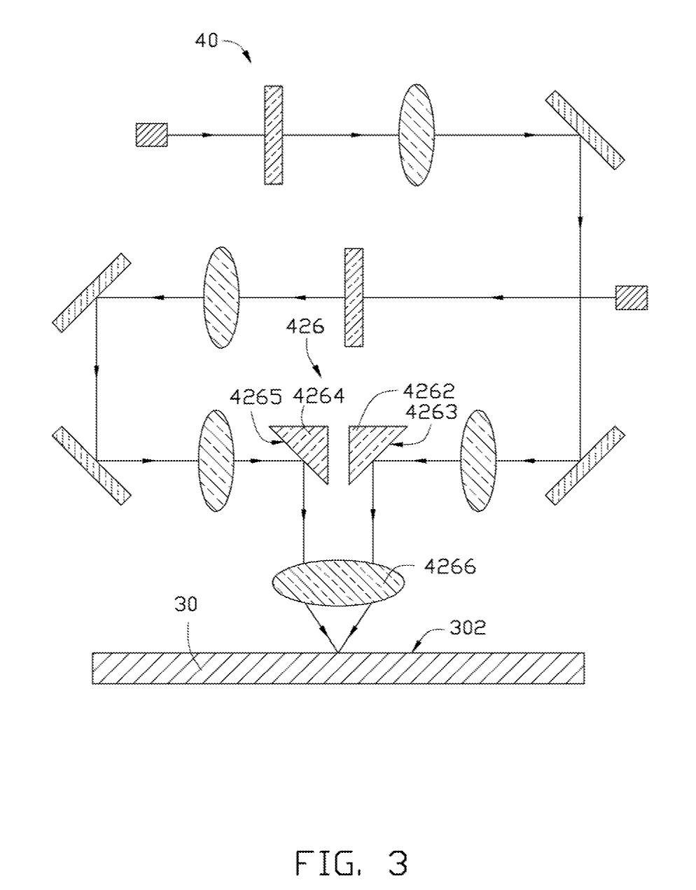

Referring to FIG. 3, a laser machining device 40, according to a second exemplary embodiment, is used to form a dot pattern including a number of dots (not shown) on a substrate 30.

The differences between the laser machining device 40 of this embodiment and the laser machining device 20 of the first embodiment are: the light-combining assembly 426 includes a first reflection unit 4262, a second reflection unit 4264, and a condensing unit 4266. The first reflection unit 4262 includes a first reflection surface 4263. The second reflection unit 4264 includes a second reflection surface 4265. The first reflection surface 4263 inclines relative to the second reflection surface 4265. The first reflection surface 4263 is symmetrical to the second reflection surface 4265. The condensing unit 4266 is a light converging lens focused on a surface 302 of the substrate 30. The first laser beam and the second laser beam are reflected by the first reflection surface 4263 and the second reflection surface 4265 in a manner that the reflected first and second laser beams are parallel to each other toward the condensing unit 4266 to form a third laser beam. The third laser beam focuses on a point of the surface 302 to form a dot.

The advantages of the laser machining device 40 of the second exemplary embodiment are similar to those of the laser machining device 20 of the first exemplary embodiment.

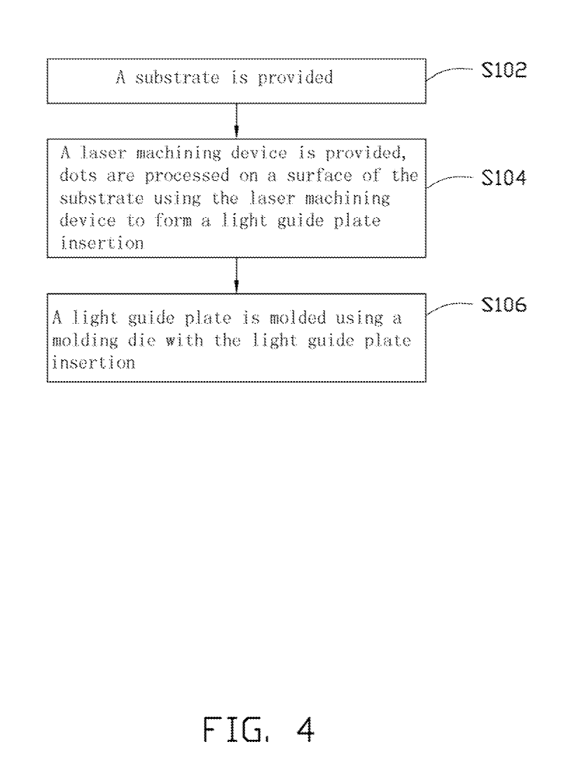

Referring to FIGS. 1-2 and 4, a method for manufacturing a light guide plate (not shown) according to a third exemplary embodiment can be implemented by, for example, the laser machining device 20 and includes the following steps. In step S102: a substrate 10 is provided. The substrate 10 includes a surface 102. The material of the substrate 10 may be acryl resin or material.

In step S104: a laser machining device 20 is provided, dots 50 are processed on the surface 102 of the substrate 10 using the laser machining device 20 to form a light guide plate insertion (not shown). In particular, the first laser beam and the second laser beam are reflected by the first reflection surface 2266 and the second reflection surface 2268 toward the condensing unit 2264 to form a third laser beam. The third laser beam focuses on a point on the surface 102 to form a dot 50. The first laser source 202 and the second laser source 212 are re-activated after the light-combining assembly 226 moves to a subsequent position along the first side 104 (positive direction on an X axis shown in FIG. 2) so that a subsequent dot 50 is formed on the surface 102. The action is repeated, a first line of dots 50 can be formed on the surface 102. The laser machining device 20 then moves along the second side 106 (positive direction on a Y axis shown in FIG. 2). The first laser source 202 and the second laser source 212 are re-activated after the light-combining assembly 226 moves to a subsequent position along the negative direction of the first side 104 (negative direction of the X axis shown in FIG. 2) so that a subsequent dot 50 is formed on the surface 102. The action is repeated, a second line of dots 50 can be formed on the surface 102. Operations are repeated until the dot pattern is formed on the surface 102.

In step S106: a light guide plate (not shown) is molded using a molding die (not shown) with the light guide plate insertion (not shown).

In other embodiments, the method for manufacturing a light guide plate (not shown) can be implemented by the laser machining device 40. In addition, the substrate 10 may be a light guide plate workpiece. After dot pattern is formed on the surface 102, the ultimate product of the light guide plate is formed. Therefore, the step S106 can be omitted. This simplifies the making method of the light guide plate and makes the cost down.

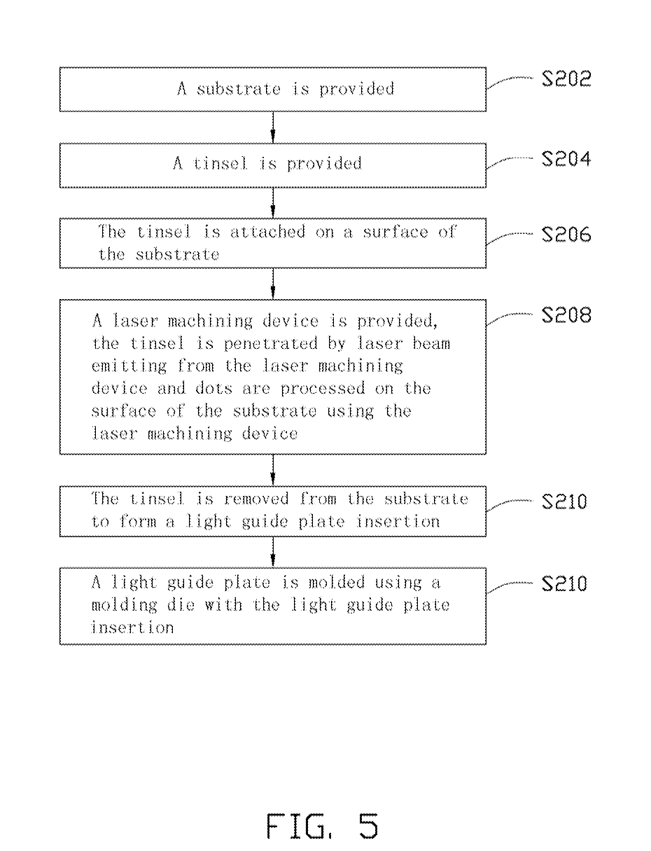

Referring to FIG. 5, a method for manufacturing a light guide plate (not shown) according to a fourth exemplary embodiment can be implemented by, for example, the laser machining device 20 and includes the following steps. In step S202: a substrate 10 is provided. The substrate 10 includes a surface 102. The material of the substrate 10 may be acryl resin or material.

In step S204: a tinsel (not shown) is provided. The tinsel has a predetermined thickness.

In step S206: the tinsel is attached on the surface 102 of the substrate 10.

In step S208: a laser machining device 20 is provided, the tinsel is penetrated by laser beam emitted from the laser machining device 20 and dots 50 are processed on the surface 102 of the substrate 10 using the laser machining device 20.

In step 210: the tinsel is removed from the substrate 10 to form a light guide plate insertion (not shown).

In step S212: a light guide plate (not shown) is molded using a molding die (not shown) with the light guide plate insertion (not shown).

The advantages of the method for manufacturing a light guide plate of the fourth exemplary are similar to those of the method for manufacturing a light guide plate of the third exemplary embodiment. Further, the tinsel with predetermined thickness can block the intensity of the edge of the laser beam. Therefore, the shape of the dots 50 will be more exact.

It is to be understood, however, that even though numerous characteristics and advantages of the present embodiments have been set forth in the foregoing description, together with details of the structures and functions of the embodiments. The disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A laser machining device for forming dots on a surface of a substrate, comprising:
a light-combining assembly having a first reflection surface and a second reflection surface;
a first laser source module configured for emitting a first laser beam to the first reflection surface along a first light path; and
a second laser source module configured for emitting a second laser beam to the second reflection surface along a second light path, the light-combining assembly configured for combining the reflected first and second laser beams into a third laser beam to focus on the surface of the substrate, wherein the light-combining assembly is moveable between the first laser source module and the second laser source module, and the second laser source module is fixed relative to the first laser source module, such that a sum of the length of the first light path and the length of the second light path is maintained constant.

2. The laser machining device as claimed in claim 1, wherein the two reflection surfaces are symmetrical to each other, an angle of incidence of the first laser beam on the first reflection surface is equal to that of the second laser beam on the second reflection surface.

3. The laser machining device as claimed in claim 2, wherein the first laser source module comprises a first laser source for emitting the first laser beam, a first light condensing element for condensing the first laser beam, a first light reflection element, and a second light reflection element, the first light reflection element and the second light reflection element configured for reflecting and directing the first laser beam toward the first reflection surface.

4. The laser machining device as claimed in claim 3, wherein the second laser source module comprises a second laser source for emitting the second laser beam, a second light condensing element for condensing the second laser beam, a third light reflection element, and a fourth light reflection element, the third light reflection element and the fourth light reflection element configured for reflecting and directing the second laser beam toward the second reflection surface.

5. The laser machining device as claimed in claim 4, wherein the first laser source module further comprises a first filter element, the first filter element is positioned between the first laser source and the first light condensing element, the second laser source module further comprises a second filter element, and the second filter element is positioned between the second laser source and the second light condensing element.

6. The laser machining device as claimed in claim 5, wherein the first laser source module further comprises a third light condensing element positioned between the second light reflection element and the light-combining assembly, the second laser source module further comprises a fourth light condensing element positioned between the fourth light reflection element and the light-combining assembly.

7. The laser machining device as claimed in claim 2, wherein the light-combining assembly comprises a reflection unit and a condensing unit, the reflection unit comprises the first reflection surface and the second reflection surface, the condensing unit is a light converging lens, the first reflection surface and the second reflection surface configured for respectively reflecting the first and second laser beams in a manner that the reflected first and second laser beams are parallel to each other.

8. The laser machining device as claimed in claim 2, wherein the light-combining assembly comprises a first reflection unit having the first reflection surface, a second reflection unit having the second reflection surface, and a condensing unit, the condensing unit is a light converging lens, the first reflection surface and the second reflection surface configured for respectively reflecting the first and second laser beams in a manner such that the reflected first and second laser beams are parallel to each other.

9. A laser machining device comprising:
a first laser source module configured for emitting a first laser beam;
a second laser source module configured for emitting a second laser beam, the second laser source module fixed relative to the first laser source;
a light-combining assembly comprising a light reflecting member and a light converging lens, the light reflecting member comprising a first reflection surface and a second reflection surface, the first and second reflection surfaces configured for respectively reflecting the first laser beam and the second laser beam in a manner such that the reflected first and second laser beams are parallel to each other, the light converging lens configured for converging the reflected first and second laser beams; and
a driving member configured for driving the light-combining assembly to move along a direction perpendicular to the reflected first and second laser beams between the first and second laser source modules.
